(19) United States
(12) Patent Application Publication
(10) Pub. No.: US 2005/0124765 A1
(43) Pub. Date: Jun. 9, 2005

(54) Adsorbent for recovering useful rare metals by adsorption

(75) Inventors: Noriaki Seko, Gunma-ken (JP); Masao Tamada, Gunma-ken (JP); Fumio Yoshii, Gunma-ken (JP)

Correspondence Address: BANNER & WITCOFF, 1001 G STREET N W, SUITE 1100, WASHINGTON, DC, 20001, US

(73) Assignee: Japan Atomic Energy Research Institute, Kashiwa-shi (JP)

(21) Appl. No.: 10/996,036

(22) Filed: Nov. 24, 2004

(30) Foreign Application Priority Data
Nov. 25, 2003 (JP) 393720/2003
Nov. 28, 2003 (JP) 398528/2003

(51) Int. Cl. C08F 265/04; C08F 210/00

(52) U.S. Cl. 525/302; 525/333.7

(57) ABSTRACT

An adsorbent for recovering useful rare metals in solution by adsorption is synthesized by forming reactive sites on a polymeric base material at first, then polymerizing reactive monomers at the reactive sites of the polymeric base material by graft polymerization, thereby forming graft chains, and introducing chelate-forming groups into the graft chains, where the polymeric base material is made of woven fabrics, non-woven fabrics, films, hollow filament films (hollow fibes) or threads of polyolefinic material such as polyethylene, polypropylene or the like, and the reactive monomers are preferably vinyl reactive monomers or vinyl reactive monomers having chelate-forming groups.

### BACKGROUND OF THE INVENTION

The present invention relates to an adsorbent for recovering useful rare metals by adsorption and a process for synthesizing the adsorbent.

Recovery of gold and silver from mineral ores has been so far carried out mostly by a cyanide process. The cyanide process has been widely used as a means for recovering metals, but produces a large amount of highly toxic cyanide liquid wastes, causing environmental problems. The cyanide process further has such disadvantages as a low reaction rate and a high susceptibility to coexisting ions, and thus research and development of new extraction processes as a substitute for the cyanide are now under way. Substitute process for the cyanide process so far proposed up to now are a thiourea process and a leaching process. It has been found that they are harmless processes and gold can be effectively recovered from the solution in the presence of an appropriate oxidizing agent. However, selection of optimum oxidizing agents for the processes has not been completed yet, and thus no satisfactory processes have been found yet for recovering useful rare metals such as gold, silver, etc.

Catalysts for automobile exhaust gas treatment carry such noble metals as platinum, palladium, rhodium, gold, etc. With the more strict global exhaust gas control, demand for such noble metals is expected to increase. To meet the demand for rare noble metals, it is necessary to reduce amounts of noble metals supported in the catalyst to save the amount of such noble metals for use in the catalysts or increase recycle rate of waste catalysts. Recovery of noble metals from the waste catalysts is carried out by a wet process. The wet process is a process comprising dipping waste catalysts in a strong acid to dissolve the noble metals, and separating and purifying the noble metals from the resulting solution by an ion exchange method using chelate resin beads or by a solvent extraction method using a chelating reagent. However, the wet process has such disadvantages that diffusion of metal ions in the chelating resin beads is a rate-determining step in the recovery from low-concentrated metal solutions, the concentration efficiency is low, etc. (e.g. K. Fujiwara: Recycle of noble metal catalysts, Chemical Engineering, vol. 55, No. 1, page 21, issued on Feb. 5, 1991 by The Society of Chemical Engineers, Japan; H. Muraki: Reduction in supported noble metal amount in automobile catalysts and catalyst preparation, Catalyst, No. 34, page 225 (1992), issued by Catalyst Science Society, Japan)

Scandium is a rare metal, whose existing quantity in the crust of the earth occupies the fifth position, i.e. substantially at the center, among all the elements. Reason why it is called a rare metal is because scandium is hard to obtain, rather than its existing quantity. Existing quantity of ores containing scandium as the main component is very small, and scandium is contained in thin ores, tungsten ores, uranium ores, etc. and now is chiefly obtained as a by-product at the uranium extraction from uranium ores. Thus, the price of scandium is 10 times as high as the price of gold that is in one-thousand existing quantity of scandium.

Research on applications of scandium has not so progressed yet due to the high price except for new applications to catalyst, etc. Recently, to obtain scandium as an important material for electronic parts, it has been so far tried to trap it from aqueous solutions containing other rare earth elements or transition elements.

Solvent extraction method is known as an industrial scale scandium recovery technique, but has an economical problem of using a large amount of solvents. A technique of recovering scandium from scandium-containing aqueous solution using resins of alkyl phosphonate esters, etc. has been recently reported, but has such problems as a low treating rate, e.g. SV (space velocity) remaining in a single figure, and a low treating quantity (e.g. JP-A-1(1989)-246328; Y. Wakui, and the other two: Selective recovery of trace scandium from acid aqueous solution with (2-Ethylhexyl hydrogen 2-ethylhexylphosphonate)-impregnated resin, Analytical Sciences, Vol. 5, pages 189-193, issued on April 1989 by the Japan Society for Analytical Chemistry).

Furthermore, there are also such disadvantages that diffusion of metal ions in chelate resins is a rate-determining step and the concentration efficiency is low.

As mentioned above, the conventional process for recovering useful rare metals have not only environmental pollution problems, but also disadvantages such as a poor recovery efficiency, a low capacity, a low adsorption rate, etc., and there has been a necessity for adsorbents capable of efficiently recover particularly gold by adsorption.

Still furthermore, the conventional scandium adsorbents have a poor stability in the adsorbing structure at the time of adsorption, because of their production by the ordinary radical polymerization, etc., or because of low-molecular weight polymer-based structure, and have been made of restricted materials (base materials).

### SUMMARY OF THE INVENTION

Objects of the present invention are to provide an adsorbent capable of recovering useful rare metals by adsorption and a process for synthesizing such an adsorbent.

As a result of extensive studies to solve the aforementioned problems, the present inventors have found an adsorbent capable of attaining a higher capacity and a higher efficiency by utilizing a graft polymerization technique in place of the so far used adsorbents. That is, one object of the present invention is to provide an adsorbent for recovering useful rare metals in solution by adsorption, which comprises a polymeric base material with graft chains bonded to the polymeric base material and with chelate-forming groups bonded to the graft chains, the chelate-forming groups being capable of forming chelates with the useful rare metals, where the chelate-forming groups are amine groups, amide groups, imine groups, imide groups or phosphate groups.

Another object of the present invention is to provide a process for synthesizing an adsorbent for recovering useful rare metals in solution by adsorption, which comprises forming reactive sites on a polymeric base material at first, then polymerizing reactive monomers at the reactive sites of the polymeric base material by graft polymerization, thereby forming graft chains, and introducing chelate-forming groups into the graft chains, where the polymeric base material is made of woven fabrics, non-woven fabrics, films, hollow filament films or threads of polyolefinic material such as polyethylene, polypropylene or the like, and the reactive monomers are preferably vinyl reactive monomers or vinyl reactive monomer with a chelate-forming group.

The present invention provides an adsorbent capable of recovering useful rare metals by adsorption and a process for synthesizing the same. The present adsorbent has two characteristics such as an increase in adsorption capacity and an increase in adsorption rate. Furthermore, according to the present invention, a metal-adsorbing function can be given to materials in various shapes by utilizing graft polymerization technique.

The present adsorbent has a stable cross-linked inside structure and thus can be used repeatedly with less damages due to adsorption-desorption. As compared with the conventional solvent extraction method requiring many steps for separating the desired substance by fixation to a medium following liquid-liquid extraction, number of steps can be reduced by using the present adsorbent, leading to shortening of treating time. Furthermore, the problem of rate-determining diffusion of metal ions as encountered in the conventional solid-liquid extraction method using the bead-shaped resin can be overcome by using the present adsorbent, and the space area for the treatment (area occupied by apparatuses) can be also reduced in the present invention.

### BRIEF DESCRIPTION OF DRAWINGS

FIG. 1 is a diagram showing a dependency of degree of grafting of allyl amine on graft polymerization time.

FIG. 2 is a diagram showing dependency of density of ethylene diamine group on conversion reaction time.

FIG. 3 is a diagram showing gold adsorption by amine group type adsorbents.

FIG. 4 is a diagram showing dependency of an amine group type adsorbent on gold adsorption time.

FIG. 5 is a diagram showing adsorption of various metals by an amine group type adsorbent.

FIG. 6 is a diagram showing adsorption of various metals by an amine group type adsorbent.

FIG. 7 is a diagram showing breakthrough curves when a 1 ppm scandium solution was passed through an adsorbent filled in a column.

FIG. 8 is a diagram showing a breakthrough curve when a 100 ppb scandium solution is passed through an adsorbent filled in a column.

FIG. 9 is a diagram showing dependency of scandium adsorption of the present adsorbent on adsorption time.

### DETAILED DESCRIPTION OF THE INVENTION

According to the first aspect of the present invention, a process for synthesizing an adsorbent for recovering useful rare metals in solution by adsorption is provided, where the process comprises forming reactive sites on a polymeric base material at first, then polymerizing reactive monomers at the reactive sites of the polymeric base material by graft polymerization, thereby forming graft chains, and introducing chelate-forming groups into the graft chains.

According to the second aspect of the present invention, an adsorbent for recovering useful rare metals in solution by adsorption is provided, where the adsorbent comprises a polymeric base material with graft chains bonded to the polymeric base material and with chelate-forming groups bonded to the graft chains, the chelate-forming groups being capable of forming chelates with the useful rare metals.

In the present invention, “useful rare metals” refers to at least one metal member selected from the group consisting of gold, platinum, palladium, rhodium, iridium, ruthenium, vanadium, cobalt, nickel, titanium, neodymium, niobium, silver, and scandium.

The polymeric base material for use in the present invention is made of woven fabrics, non-woven fabrics, films, hollow filament films (hollow fibers) or threads of polyolefinic materials such as polyethylene, polypropylene, etc.

Reactive monomers for use in the present invention are vinyl reactive monomers. The reactive monomers are specifically at least one member selected from the group consisting of allyl amine, glycidyl methacrylate, and glycidyl acrylate. The reactive monomers can have chelate-forming groups such as amine groups, amide groups, imine groups, imide groups, phosphate groups, etc. When reactive monomers having chelate-forming groups are used, the chelate-forming groups can be introduced directly into graft chains by graft polymerization of such reactive monomers, so it is not particularly necessary to conduct reaction to introduce the chelate-forming groups, as will be explained later.

In place of homo-polymerization of vinyl reactive monomers, it is possible to conduct co-graft polymerization of vinyl reactive monomers with at least one hydrophilic vinyl monomer selected from the group consisting of acrylic acid, methacrylic acid and N-vinyl acetamide. When the vinyl reactive monomers have a poor compatibility with or a poor affinity toward metals to be adsorbed or solution containing such metals, copolymerization with hydrophilic monomer can improve the salvation (characteristics). When the vinyl reactive monomers themselves are hydrophobic or are poor in reactivity, it is preferable to use the hydrophilic vinyl monomer as a co-monomer component, because the affinity can be improved and the reaction can proceed successively as a consequence of the reaction of the co-monomer component.

In case of using an amine group as a chelate-forming group, allyl amine can be used as a reactive monomer having an amine group.

In case of using a phosphate group as a chelate-forming group, mono-(2-methacryloyloxyethyl)acid phosphate: CH₂═C(CH₃)COO(CH₂)₂OPO(OH)₂, di-(2-methacryloyloxyethyl)acid phosphate: [CH₂═C(CH₃)COO(CH₂)₂O]₂PO(OH), mono-(2-acryloyloxyethyl)acid phosphate: CH₂═CHCOO(CH₂)₂OPO(OH)₂, di-(2-acryloyloxyethyl)acid phosphate: [CH₂═CHCOO(CH₂)₂O]₂PO(OH) or their mixed monomers can be used as a reactive monomer having a phosphate group.

In case of using mixed monomers, a mixing ratio of the individual monomers can be changed, as desired.

Furthermore, a monomer having the following chemical formula can be used also as a reactive monomer having a phosphate group: CH₂═C(CH₃)COO(CH₂)₁OCO—R—CO—OPO(OH)R′ where R is (CH₂)ₘ or C₆H₄, which may have a substituent, R′ is a hydroxyl group or CH₂═C(CH₃)COO(CH₂)ₙOCO—R—CO—O— group, and l, m and n each are independently an integer of 1 to 6.

The present process for synthesizing an adsorbent comprises the following three reaction steps: (1) step of reactive site formation reaction for forming reactive sites on a polymeric base material, (2) graft polymerization reaction step for graft polymerization of reactive monomers at the reactive sites on the polymeric base material, and (3) chelate-forming group introduction reaction step for introducing into graft chains groups capable of inducing chelate-forming groups, followed by conversion reaction. In case of using reactive monomers having chelate-forming groups, the process for synthesizing an adsorbent can be carried out in two steps (1) and (2) while omitting the chelate-forming group introduction reaction step (3).

(1) Reactive Site Formation Reaction

Reaction sites can be formed on the polymeric base material by any one of the following methods (a) to (c):

(a) Irradiation with Radiation

Polymeric base material flushed with nitrogen in advance is irradiated with radiation at room temperature or with cooling by dry ice, etc. in a nitrogen atmosphere. The radiation to be used for this purpose is an electron beam or γ-rays. Irradiation dose can be selected, as desired, so long as the dose is sufficient for forming reactive sites, and the dose typically is in a range of 50-200 kGy.

(b) Irradiation with Plasma

Polymeric base material flushed with nitrogen in advance is irradiated with plasma at a high frequency of 10 MHz or more at room temperature in a nitrogen atmosphere for one to a few hours.

(c) Use of an Initiator

Under nitrogen bubbling, monomers are mixed with a radical initiator in a range of room temperature to 50° C. The radical initiator to be used for this purpose includes, for example, azobisisobutyronitrile and benzoyl peroxide.

(2) Graft Polymerization Reaction

After the reactive site formation reaction, graft polymerization is carried out by bringing the polymeric base material into contact with reactive monomers to introduce graft chains of reactive monomers into the base material.

Graft polymerization can be carried out in a nitrogen atmosphere, but it is preferable for attaining a higher degree of grafting that the oxygen concentration of the atmosphere is lower. The term “degree of grafting” herein used is a ratio (%) by weight of reactive monomer grafted onto the polymeric base material to the polymeric base material. Reaction temperature depends on reactivity of reactive monomers, and typically in a range of 40° C. to 60° C., preferably 40° C. Reaction time is in a range of 30 minutes to 5 hours, but can be determined in view of the reaction temperature and the desired degree of grafting. Monomer concentration in polymerization reaction solvent (in case of copolymerization, total monomer concentration) is normally about 10%, and together with the reaction temperature and the reaction time it is a degree of grafting-determining factor and thus can be likewise selected as desired. Polymerization solvent can be selected, as desired, in view of monomers to be used, and typically alcohols such as water, methanol, etc., aprotic polar solvents such as dimethyl sulfoxide, dimethyl formamide; esters; and their mixtures can be used.

(3) Chelate-forming group introduction reaction

After formation of graft chains by the graft polymerization reaction, chelate-forming groups are introduced into the graft chains by reaction with a compound having a chelate-forming group. The term “chelate-forming group” herein used means such groups as to form chelates with useful rare metals in solution, thereby exerting an adsorbent effect, and they include, for example, amine groups, amide groups, imine groups, imide groups, and phosphate groups.

When graft chains are formed by graft polymerization reaction of allyl amine, amine groups as chelate-forming groups are directly introduced into the resulting graft chains at the time of the graft polymerization, and thus the chelate-forming groups introduction reaction can be omitted in this case.

In the present invention, a compound having a chelate-forming group can be selected from the group consisting of compounds having amine group, an amide group, an imine group, an imide group, or a phosphate group, their derivatives, and their mixtures. Compounds having amine group include, for example, primary amines (RNH₂), secondary amines (R₂NH), and tertiary amines (R₂N), where R is a hydrocarbon group; and their derivatives such as amides (RCONH₂) and polyamines. Compounds having an imine group (—C═Nr) can be those with the imine group whose hydrogen atom can be replaced with an alkyl group (—C═NR), or can be polyimines. Compounds having an imide group (RR′NH) can be ethers as their derivatives RC(═NH)OR, where R is an alkyl group. Compounds having a chelate-forming group for use in the present invention include specifically alkylamine, ethylene diamine, ethylene amine, ethylene tetramine, polyamine, guanidine, guanidine hydrochloride, guanilic acid (C₁₀H₁₄N₅O₈P), etc.

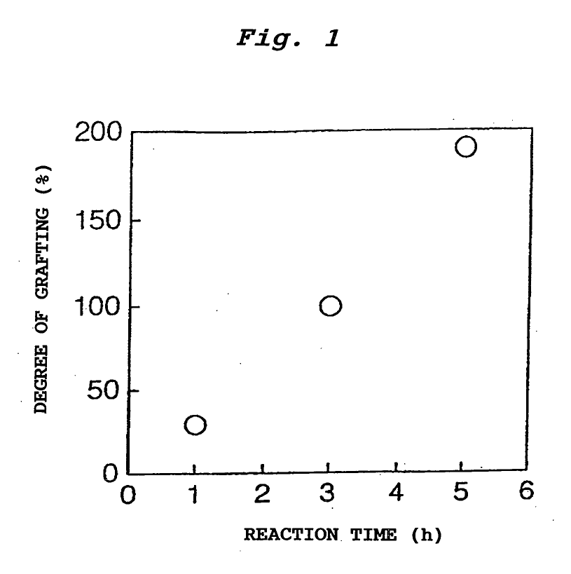

For example, in the case of an adsorbent having amine group, the reaction time can be selected in view of amine group density resulting from the reaction. Dependency of amine group density on reaction time is shown in FIG. 1.

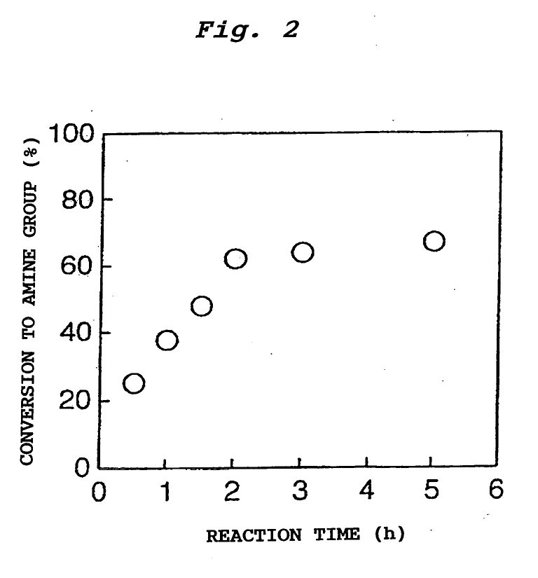

Glycidyl groups introduced into the graft chains can be converted to amine groups, for example, by reaction with ethylene diamine. Conversion (reaction) time to amine groups by ethylene diamine depends on conversion (%) to amine groups, as shown in FIG. 2.

In the present invention, adsorbed rare metals can be recovered by an eluent, and the adsorbent following elution can be recycled by washing. As an eluent, an acid such as an inorganic or organic acid, or an alkali can be used. Specifically, the adsorbed rare metals are eluted from the adsorbent by an eluent, while the resulting adsorbent is washed with deionized water, and then dipped into 0.5 M hydrochloric acid and 0.5 M sodium hydrochloride once each for one hour alternatingly.

The present invention will be explained in detail below, referring to Examples, which should be construed as not restrictive of the present invention.

### EXAMPLE 1

Synthesis of amine group type adsorbent using a non-woven fabric as a polymeric base material

Non-woven fabric was used as a polymeric base material, and reactive sites were formed thereon by irradiation with radiation. Irradiation with radiation was carried out at a dose of 200 kGy in a nitrogen atmosphere. Then, monomers consisting of a mixture of allyl amine and N-vinyl acetamide in a ratio of the former to the latter of 90:10 by weight were dissolved into deionized water at a concentration of 50% by weight, and the polymeric base material was dipped in the solution to conduct graft copolymerization at 40° C. for 30 minutes to 5 hours. Degree of grafting was 70 to 300%.

Likewise, monomers consisting of a mixture of allyl amine and acrylic acid, and those consisting of a mixture of N-vinyl acetamide and amidoxime were subjected to graft polymerization, respectively, to synthesize adsorbents.

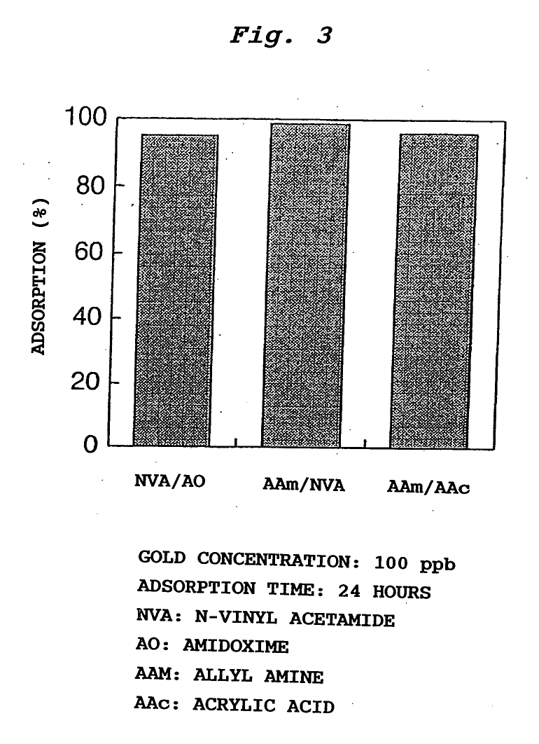

The resulting individual non-woven fabric adsorbents were dipped each into an aqueous 10 ppb gold solution with stirring for 4 hours to evaluate adsorbabilities of the adsorbents. Each of the adsorbents could recover 96% or more gold (FIG. 3).

### EXAMPLE 2

Synthesis of amine group type adsorbent using monofilaments as a polymeric base material

Hollow filament film was used as a polymeric base material, and reactive sites were formed thereon by irradiation with radiation. Irradiation with radiation was carried out with an electron beam or γ-rays in a nitrogen atmosphere at a total dose of 200 kGy. Then, monomers consisting of a mixture of allyl amine and N-vinyl acetamide in a ratio of the former to the latter of 90:10 by weight were dissolved into deionized water at a concentration of 50% by weight, and the polymeric base material was dipped in the solution to conduct graft copolymerization at 40° C. for 30 minutes to 7 hours to conduct graft polymerization. Degree of grafting was 120 to 300%.

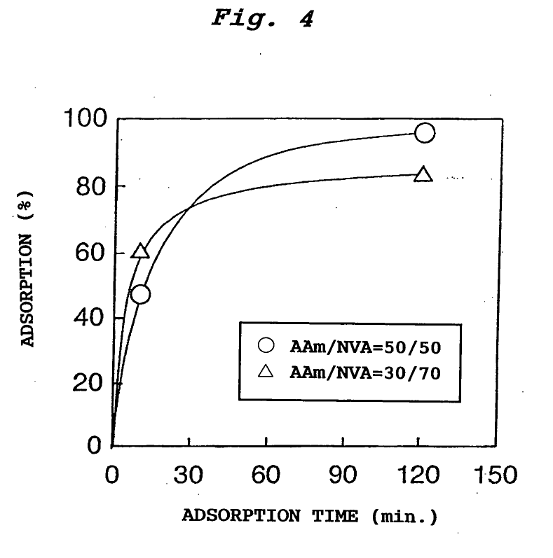

The resulting adsorbent was dipped into an aqueous 1 ppm gold solution with stirring, and it was found that 96% or more of gold could be recovered for 2 hours (FIG. 4).

### EXAMPLE 3

Adsorption Test of Amine Group Type Adsorbent

After irradiation of the polymeric base material in the same manner as in Example 2, glycidyl methacrylate was diluted to a concentration of 10% by weight with methanol as a solvent, and the polymeric base material was dipped in the resulting glycidyl methacrylate solution at 40° C. for 5 minutes to 2 hours to conduct graft polymerization. Degree of grafting was 100 to 300%. Then, the grafted polymeric base material was dipped into an aqueous 50% ethylene diamine solution at 40° C. for 4 hours to convert the glycidyl groups on the grafted chains to amine groups. Conversion was 60%.

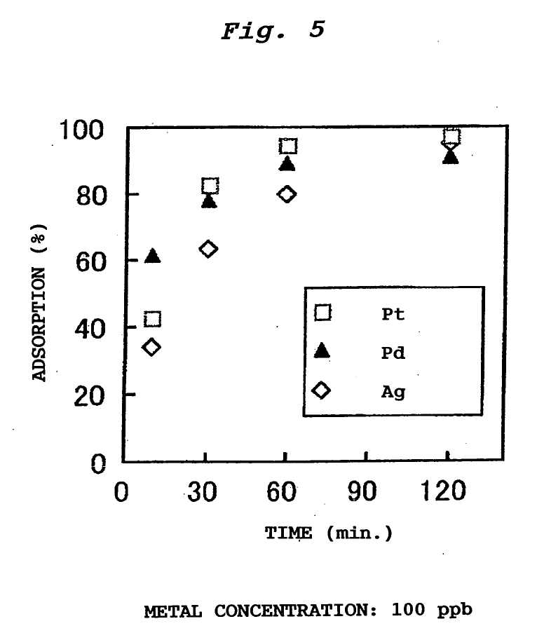

The resulting adsorbent was dipped each into an aqueous 100 ppb platinum solution, an aqueous 100 ppb palladium solution and an aqueous silver solution with stirring, and it was found that 95% or more of all the metal species could be recovered for 2 hours, and particularly platinum could be substantially completely recovered for one hour (FIG. 5).

### EXAMPLE 4

Adsorption Test of Amine Group Type Adsorbent

After irradiation of the polymeric base material in the same manner as in Example 2, monomers consisting of a mixture of allyl amine and N-vinyl acetamide in a ratio of the former to the latter of 50:50 by weight were dissolved into deionized water at a concentration of 50% by weight, and the polymeric base material was dipped in the resulting solution at 50° C. for 5 hours to conduct graft polymerization. Degree of grafting was 150%.

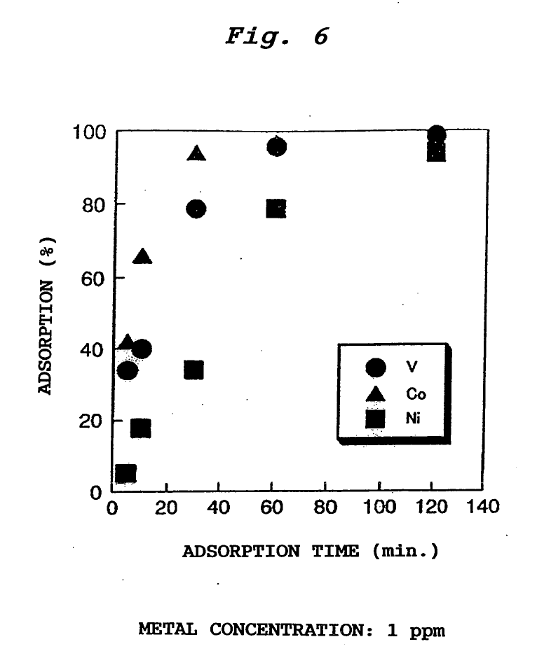

The resulting adsorbent was dipped each into an aqueous 1 ppm vanadium solution, an aqueous 1 ppm cobalt solution and an aqueous 1 ppm nickel solution with stirring, and it was found that 95% or more of all the metal species could be recovered for 2 hours (FIG. 6). When similar test was conducted at a low metal concentration (10 ppb), it was found that all the metal species could be recovered down to 1 ppb or less for one hour (not shown in the drawing).

### EXAMPLE 5

Synthesis of Phosphate Group Type Adsorbent Using Non-Woven Fabric as a Polymeric Base Material

Non-woven fabric was used as a polymeric base material, and monomers consisting of a mixture of mono-(2-methacryloyloxyethyl)acid phosphate and di-(2-methacryloyloxyethyl)acid phosphate in a ratio of the former to the latter of 70:30 by weight were used as monomers having a phosphate group. The mixtures of the monomers were dissolved into a mixed solvent of methanol and deionized water (methanol: 10-30 wt %) at a total concentration of 10 to 30% by weight.

The polymeric base material was irradiated with an electron beam at a dose of 200 kGy at room temperature in a nitrogen atmosphere, and immediately after the irradiation, the base material was dipped into the aforementioned solution containing the monomers having a phosphate group at 40° C. to 60° C. for 3 to 24 hours to conduct graft polymerization, thereby introducing graft chains into the non-woven fabrics. Degree of grafting was 100 to 400%. In case of graft polymerization at 60° C. for 2 hours and 12 hours, the degrees of grafting were 90% and 120%, respectively. Phosphate group introduction efficiently was 4 to 8 mmol/g.

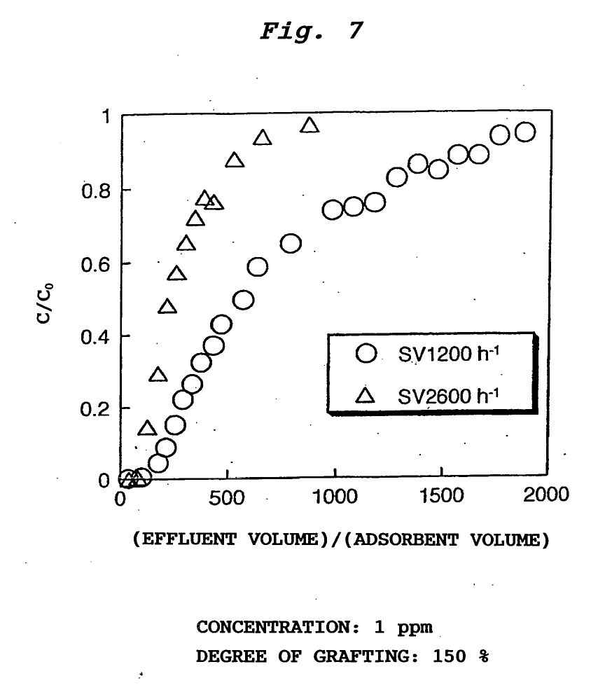

For activation, the resulting adsorbent was dipped into an aqueous 0.5 M sodium hydroxide solution for one hour, and then into an aqueous 0.5 M hydrochloric acid solution for one hour with stirring, and preserved in a wet state until application to prevent actively degradation by drying. Upon application, the preserved adsorbent was washed with washing water (deionized water) until the pH became neutral. Then, the washed adsorbent (degree of grafting: 150%) was filled into an adsorption column, and an aqueous 1 ppm scandium solution (pH 2) was passed through the column at a flow rate of 180 ml/h (space velocity: 1,200 h⁻¹). Breakthrough point was found to be about 150. When the flow rate was changed to space velocity of 2,600 h⁻¹, the breakthrough point was found to be substantially the same (FIG. 7).

Adsorbents using non-woven fabric obtained in the foregoing examples can be used by themselves as filters and their application can be made versatile by processing or lamination into various shapes.

### EXAMPLE 6

Adsorption Test of Phosphate Group Type Adsorbent

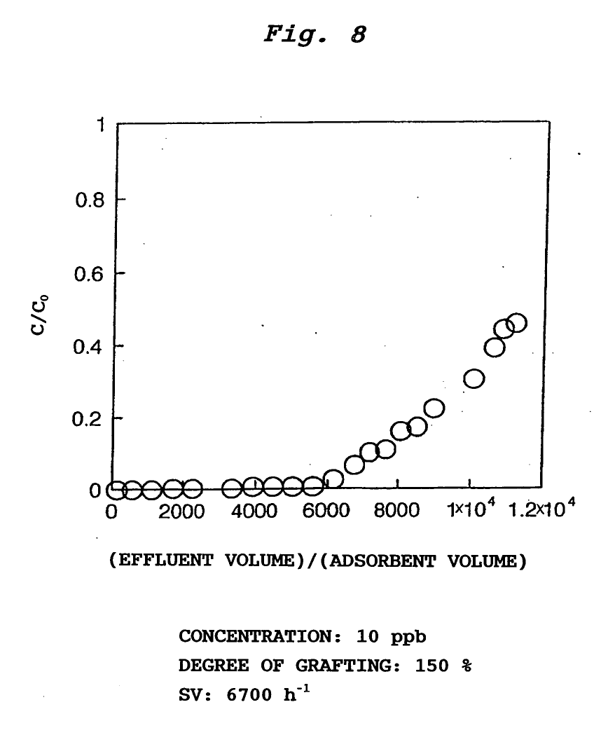

The adsorbent (degree of grafting: 150%) synthesized as in the same manner in Example 5 was subjected to an adsorption test using an aqueous 100 ppb scandium solution. Breakthrough point was found to be about 6,000 at a space velocity (SV) of 6,700 h⁻¹ (FIG. 8), and at a space velocity in 3 figures the breakthrough point was found to 10,000 or more (not shown in the drawing).

### EXAMPLE 7

Adsorption Test of Phosphate Group Type Adsorbent

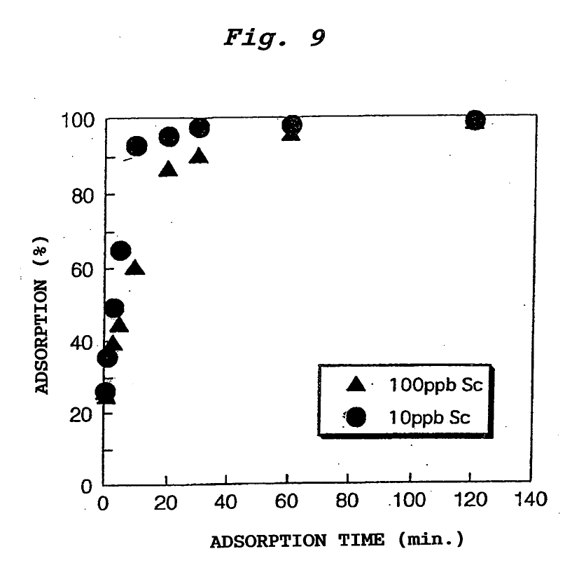

The adsorbent synthesized in the same manner as in Example 5 was dipped each into an aqueous 10 ppb scandium solution and an aqueous 100 ppb scandium solution, with stirring at a constant temperature. It was found that 90% or more of scandium could be trapped for a contact time of 30 minutes in both cases (FIG. 9).

1. A process for synthesizing an adsorbent for recovering useful rare metals in solution, which comprises forming reactive sites on a polymeric base material at first, then polymerizing reactive monomers at the reactive sites of the polymeric base material by graft polymerization, thereby forming graft chains, and introducing chelate-forming groups into the graft chains.

2. A process according to claim 1, wherein the polymeric base material is made of a woven fabric, a non-woven fabric, a film, a hollow filament film or thread of polyolefinic material such as polyethylene, polypropylene or the like.

3. A process according to claim 1 or 2, wherein the reactive monomers are vinyl reactive monomers.

4. A process according to any one of claims 1 to 3, wherein the reactive monomers are vinyl reactive monomer with a chelate-forming group.

5. A process according to any one of claims 1 to 4, wherein the graft polymerization is a co-graft polymerization with at least one hydrophilic vinyl monomer selected from the group consisting of acrylic acid, methacrylic acid, and N-vinyl acetamide.

6. A process according to any one of claims 1 to 5, wherein the chelate-forming group is an amine group, an amide group, an imine group, an imide group or a phosphate group.

7. A process according to any one of claims 1 to 6, wherein the useful rare metals to be recovered by adsorption are at least one metal member selected from the group consisting of gold, platinum, palladium, rhodium, iridium, ruthenium, vanadium, cobalt, nickel, titanium, neodymium, niobium, silver, and scandium.

8. An adsorbent for recovering useful rare metals in solution by adsorption, which comprises a polymeric base material with graft chains bonded to the polymeric base material and with chelate-forming groups for forming chelates with useful rare metals, the chelate-forming groups being bonded to the graft chains.

9. An adsorbent according to claim 8, wherein the chelate-forming groups are amine groups, amide groups, imine groups, imide groups or phosphate groups.

10. An adsorbent according to claim 8 or 9, wherein the useful rare metals to be recovered by adsorption are at least one metal member selected from the group consisting of gold, platinum, palladium, rhodium, iridium, ruthenium, vanadium, cobalt, nickel, titanium, neodymium, niobium, silver, and scandium.

11. An adsorbent according to any one of claims 8 to 10, wherein the used adsorbent can be recycled by washing with an eluent.
